(19) United States
(12) Patent Application Publication
(10) Pub. No.: US 2024/0314170 A1
(43) Pub. Date: Sep. 19, 2024

(54) SYSTEM AND METHOD FOR ENTERPRISE CYBERSECURITY BASELINE CLASSIFICATION

(71) Applicant: SAUDI ARABIAN OIL COMPANY, Dhahran (SA)

(72) Inventors: Mohammed A. Alfraih, Khobar (SA); Johara A. Aljarri, Dammam (SA)

(73) Assignee: SAUDI ARABIAN OIL COMPANY, Dhahran (SA)

(21) Appl. No.: 18/186,009

(22) Filed: Mar. 17, 2023

(51) Int. Cl. H04L 9/40

(52) U.S. Cl. CPC H04L 63/20; H04L 63/1433

(57) ABSTRACT

A method and a system for enterprise cybersecurity baseline classification. The method includes obtaining an application admission request to enter a cybersecurity infrastructure and generating an assessment of the application based on a predetermined baseline selection criteria. Further, an assessment of the application is generated based on a predetermined requirement criteria and a classification of the application is determined based on the assessments, wherein the application is classified as critical or non-critical. Further, the method includes developing a security baseline for the application classified as critical and updating a cybersecurity management database with information on the classification of the application.

### BACKGROUND

Cybersecurity may include the protection of an organization's data or/and infrastructure from both outside threats as well as individuals within an organization that may compromise the data, cause denial of service or other sort of attacks. Quantifying these threats, preventing and responding to them when they occur, as part of an overall risk management, is an important aspect to identifying an organization's cybersecurity state. Accordingly, it is commonly needed among many organizations to continuously benchmark their cybersecurity state against an international or customized standard or framework to identify how mature their cybersecurity state is, how much they are in compliant with recommended practices and where the areas of improvements are.

Every system or application connected to corporate network requires a security baseline according to the Fifth control of Center of Internet Security (CIS) to ensure an organization's cybersecurity. This control is also highlighted as an essential cybersecurity control in NIST Cybersecurity Framework to manage cybersecurity risks. Embedding system or application criteria in the admission process can help achieve the goal of classifying critical systems, to enhance regular compliance checks against critical systems and ensures that system and applications that didn't pass the criteria is configured using generic security controls, and it helps cybersecurity personnel in monitoring critical applications/systems to the organization.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method. The method includes obtaining an application admission request to enter a cybersecurity infrastructure and generating an assessment of the application based on a predetermined baseline selection criteria. Further, an assessment of the application is generated based on a predetermined requirement criteria and a classification of the application is determined based on the assessments, wherein the application is classified as critical or non-critical. Further, the method includes developing a security baseline for the application classified as critical and updating a cybersecurity management database with information on the classification of the application.

In general, in one aspect, embodiments disclosed herein relate to a system including a network comprising a plurality of network elements, a hardware probe coupled to the plurality of network elements, and a network element coupled to the plurality of network elements, the network element comprising a software probe, and a computer processor, wherein the computer processor is coupled to the hardware probe, the software probe, and the plurality of network elements. Further, the computer processor comprises functionality for obtaining an application admission request to enter a cybersecurity infrastructure and generating an assessment of the application based on a predetermined baseline selection criteria. Further, a classification of the application is determined based on the predetermined baseline selection criteria and an assessment of the application is generated based on a predetermined requirement criteria. Further, a security baseline is developed for the application classified for a baseline selection and a cybersecurity management database is updated with information on the classification of the application.

In general, in one aspect, embodiments disclosed herein relate to a non-transitory computer readable medium storing a set of instructions executable by a computer processor, the set of instructions including the functionality for obtaining an application admission request to enter a cybersecurity infrastructure and generating an assessment of the application based on a predetermined baseline selection criteria. Further, a classification of the application is determined based on the predetermined baseline selection criteria and an assessment of the application is generated based on a predetermined requirement criteria. Further, a security baseline is developed for the application classified for a baseline selection and a cybersecurity management database is updated with information on the classification of the application.

Other aspects and advantages of the claimed subject matter will be apparent from the following description and the appended claims.

### BRIEF DESCRIPTION OF DRAWINGS

Specific embodiments disclosed herein will now be described in detail with reference to the accompanying figures. Like elements in the various figures are denoted by like reference numerals for consistency. Like elements may not be labeled in all figures for the sake of simplicity.

FIG. 1 shows a system in accordance with one or more embodiments.

FIG. 2 shows a flowchart in accordance with one or more embodiments.

FIG. 3 shows a flowchart in accordance with one or more embodiments.

FIGS. 4A and 4B shows an example in accordance with one or more embodiments.

FIG. 5 shows a computing system in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

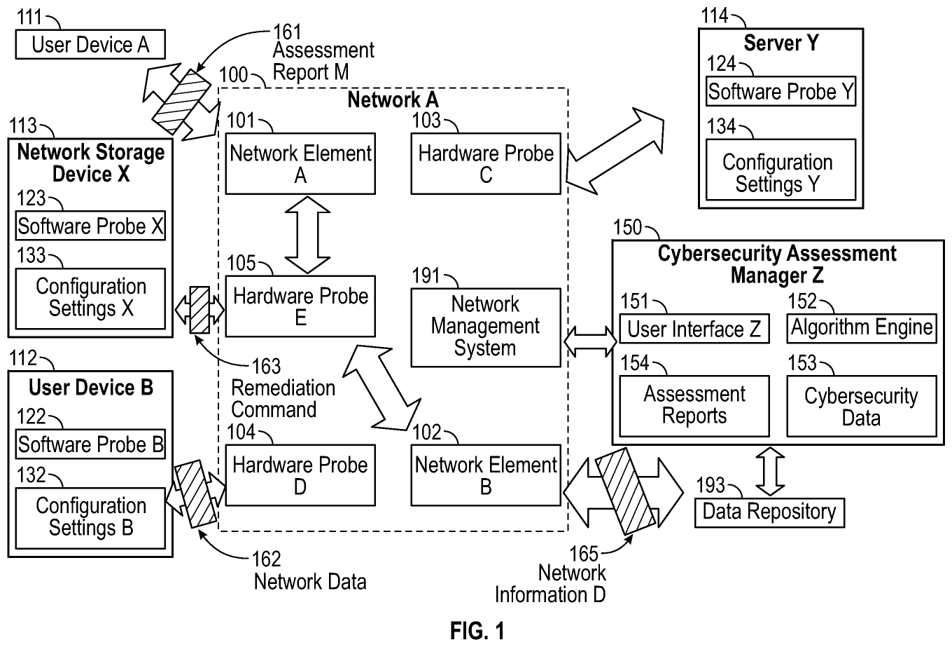

In the following description of FIGS. 1-5, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments disclosed herein provide a method and system for assurance, monitoring, and classification of availability of continuous data security of infrastructure, endpoints, and other organization aspects. The infrastructure may include communication infrastructure (such as cellular wireless network links or leased lines or satellite links), network infrastructure (such as switches, routers and links between them), computing infrastructure (such as servers and storage devices that include premise-based or cloud-based devices), and/or cybersecurity infrastructure (such as Firewalls, IDS, IPS, etc.). The endpoints may include user devices (e.g., PCs, mobile devices) or peripherals. Other organization aspects may include the availability of approved cybersecurity strategies, policies, procedures and workforce certifications. For brevity, “infrastructure and endpoints” (or “network or organization”) may be used hereinafter to imply the holistic scope mentioned above.

Furthermore, the cyber risk focused method of embodiments disclosed herein checks every system or application admitted to the infrastructure and endpoints and examines criticality and risk of a given system or application to the infrastructure. When systems and applications meet all conditions predefined in the criteria, a security baseline may be developed to address the security configurations. In contrast, when the systems and application do not meet all conditions predefined in the criteria, the system or application should follow generic security controls such as NIST, DOD or enterprise's cybersecurity controls.

In one or more embodiments, a cybersecurity baseline is a procedure that defines the minimum-security configuration controls to ensure that a given system is hardened against potential cybersecurity risk. A high security system should have a baseline to define the minimum-security configuration on that specific system. However, in corporate environment where a high number of systems are admitted on regular basis, every system does not have a cybersecurity baseline. Moreover, the cybersecurity operations must ensure that each system is compliant with the cybersecurity baseline. It is impractical to have a cybersecurity baseline for every system and/or application admitted to corporate network as it will overwhelm cybersecurity personnel in the assurance and compliance process. With the increasing number of systems, a risk focused approach is needed to create cybersecurity baseline. As such, the classification of systems starts to emerge as a critical pillar in terms of identifying systems that needs to be checked on a regular basis and other systems that can follow a specific predefined set of security configurations controls.

Additionally, the method disclosed herein generates the report of the applications' classifications that may be critical for the cybersecurity of the entire network. To perform a cybersecurity assurance, monitoring, and classification, multiple hardware probes and multiple software probes may be disposed around a network in order to collect data for analyzing cybersecurity risks as well as detect changes to the cybersecurity state of the network. For example, hardware probes may monitor inline network traffic as the data passes through particular nodes along a network path. On the other hand, software probes may be installed on various network elements to monitor configuration settings and other system data in order to provide a security picture of the infrastructure system or endpoints in a network. More specifically, a cybersecurity assessment may use one or more assessment models that provide a metric for analyzing specific cybersecurity areas of an organization as well as for determining an overall cybersecurity picture of the organization against one or more cybersecurity standards or frameworks.

One or more embodiments include a cybersecurity assessment manager that provides an autonomous process that determines cybersecurity classification and compliance with security standards. More specifically, where a cybersecurity assessment is conducted manually by using a human assessor, a cybersecurity assessment manager may provide a hardware and/or software implementation on a network that reduces the amount of human subjectivity involved in assessments. Where a human assessor may sample a small selection of evidence to evaluate cybersecurity risks, a cybersecurity assessment manager may obtain a complete and accurate picture of a network or organization using multiple probes. Because a human assessor's determination may be dependent on an assessor's judgment, the cybersecurity assessment manager may provide a repeatable objective assessment that eliminates human intervention through autonomous processes. Accordingly, a cybersecurity assessment manager may assess classification of cybersecurity data through extensive data collection and consistent application of metrics.

Additionally, the systems and applications should have a documented admission process to maintain an inventory of systems and applications admitted to corporate network. Embedding system or application criteria in the admission process can help achieve the goal of classifying critical systems. This process enhances regular compliance checks against critical systems and ensures that system and applications that do not pass the criteria are configured using generic security controls. The generic security controls include, at least, user and password management, enabling and disabling protocols, and applying secure encryption algorithms. Further, this process helps cybersecurity personnel in monitoring critical applications and systems to the organization.

The testing criteria is predetermined by a user analyst to define route for the system or application during the assessment process. The testing criteria may be a set of requirements that the application or system are assessed on based on the provided application information. Further, the testing criteria may be, at least, a baseline selection criteria and a requirements criteria. In one or more embodiments, a baseline selection criteria is a set of metrics, conditions, standards, and measures used to determine whether or not a baseline is necessary. Further, the baseline selection criteria may include, at least, requirements such as the application being an off the shelf product and not having a custom code, the application having an editable configuration, and the application being standalone application and not being a part of the existing baseline. Additionally, in one or more embodiments, cybersecurity is a set of requirements that is taken into account when analyzing systems to determine whether a baseline is necessary. The cybersecurity may include, at least, requirements such as the application's cybersecurity tier, application's admittance to intranet or extranet zone, a number of employees using the application, or any requirement that is determined as viable to the cybersecurity analyst.

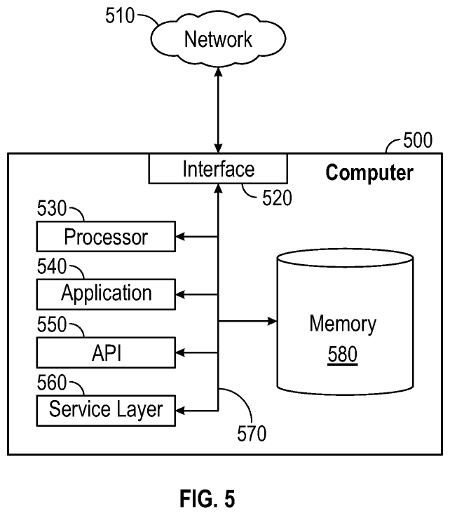

Turning to FIG. 1, FIG. 1 shows a schematic diagram in accordance with one or more embodiments. As shown in FIG. 1, a network (e.g., network (100)) may be coupled to various user devices (e.g., user device A (111), user device B (112)), one or more servers (e.g., server Y (114)), a network storage device (e.g., network storage device X (113)), various network elements (e.g., network element A (101), network element B (102)). A network element may refer to various hardware components within a network, such as switches, routers, and hubs, as well as user devices, servers, network storage devices, user equipment, or any other logical entities for uniting one or more physical devices on the network. User devices may include personal computers, smartphones, human machine interfaces, and any other devices coupled to a network that obtain inputs from one or more users. In some embodiments, a network includes a cybersecurity assessment manager (e.g., cybersecurity assessment manager Z (150)). The cybersecurity assessment manager Z (150) includes hardware and/or software that includes functionality for determining cybersecurity risks and/or remediating the cybersecurity risks, such as restarting network devices, performing connection tests, and implementing security protocols, etc. In some embodiments, a cybersecurity assessment manager, network elements, user equipment, user devices, servers, and/or a network storage device may be computing systems similar to the computing system (500) described in FIG. 5, and the accompanying description.

In some embodiments, a network (e.g., network A (100)) includes a log system that obtains cybersecurity data using hardware probes (103-105), software probes (122-124), and the network management system (191). The log system obtains data from operating systems, firewalls, proxy, routers, modems, etc. These data sources are the sources from which cybersecurity data discussed herein is monitored/collected. As such, network A (100) includes one or more hardware probes (e.g., hardware probe C (103), hardware probe D (104), hardware probe E (105)). In particular, a hardware probe may include hardware that includes functionality to monitor inline data transmissions, such as data sent between endpoints communicating over network paths or data sent between network elements as shown in hardware probe E (105). For example, hardware probe D (104) may perform a packet analysis on network data (162) that is transmitted by user device B (112) to server Y (114) to determine one or more security vulnerabilities or noncompliance with one or more security protocols. Thus, various hardware probes may collect network information regarding security control implementations, security protocols, and other types of security information directly from network traffic. Hardware probes may further transmit such network information (e.g., network information D (165) to a cybersecurity assessment manager for further analysis.

In some embodiments, for example, the cybersecurity assessment manager Z (150) includes functionality for receiving information from the network management system (191) regarding systems and applications added to the cybersecurity infrastructure. As such, a hardware probe may include hardware that performs a packet analysis to identify and categorize inbound and outbound running applications by monitoring network traffic. Thus, hardware probes determine a presence and/or violation of one or more security metrics through a packet analysis. In some embodiments, for example, a hardware probe detects any activity within a network element and transmits the information regarding the activity and the network element to the data repository (193). Thus, hardware probes may identify devices within a network and their respective cybersecurity risks based on analyzing network traffic.

In some embodiments, the network (e.g., network A (100)) includes one or more software probes. For example, a software probe may be software installed on a network element (e.g., software probe X (123), software probe B (122) on user device B (112), software probe Y (124)) for monitoring potential security vulnerabilities associated with the network element. For example, a software probe may include functionality to identify various configuration settings (e.g., configuration settings B (132), configuration settings X (133), configuration settings Y (134)), such as security controls, network communication settings, and/or various security protocols performed using the network element. In some embodiments, a software probe may compare configuration settings to one or more predetermined security policies, security controls, and/or baselines to identify compliance issues and other security vulnerabilities.

Returning to the cybersecurity assessment manager, the cybersecurity assessment manager Z (150) may include hardware and/or software that includes functionality for collecting cybersecurity data (e.g., cybersecurity data (153)) over a network using various hardware probes and software probes. In some embodiments, the cybersecurity assessment manager obtains cybersecurity data by interfacing and extracting information from other management systems in a network or among an organization's infrastructure. In particular, the cybersecurity assessment manager Z (150) may request an application information from a Data Repository (193) and/or a network management system (e.g., network management system Y (191)). Alternatively, the cybersecurity assessment manager Z (150) may be supplied with the application information directly by the user. In some embodiments, the cybersecurity assessment manager Z (150) is implemented in a cloud computing environment by a cloud server, where the cloud server may obtain the data from various probes over various internet connections. Where cybersecurity data may be generated by a cybersecurity assessment manager, in some embodiments, hardware probes and/or software probes may directly generate the cybersecurity data.

In some embodiments, the cybersecurity assessment manager Z (150) obtains user inputs from one or more user devices regarding added systems and applications and information on the added systems and applications. The information may indicate a type of system and application, a presence of a custom code, a presence of editable configuration, a presence of a security baseline, etc. In some embodiments, a cybersecurity assessment manager includes hardware and/or software such as an algorithm engine (152) for analyzing data received from the network management system (191) and the Data Repository (193). For example, the algorithm engine may analyze the received cybersecurity data, applications, and systems to verify the newly added network elements and to assess the route of the network elements during the review process.

In some embodiments, the cybersecurity assessment manager Z (150) includes functionality for transmitting one or more remediation commands (e.g., remediation command (163)) based on one or more classification assessment of the network elements. In particular, a remediation command may be a network message that causes one or more remediation procedures to be performed automatically by a network element. Examples of remediation procedures include one or more of the following: applying a standardized set of generic security controls; developing a security baseline; storing the results of assessment to a data repository (193). In some embodiments, the cybersecurity assessment manager Z (150) includes a remediation queue that organizes the sequence that remediation procedures are implemented in a network.

In some embodiments, the cybersecurity assessment manager Z (150) includes hardware and/or software that provides a user interface (e.g., user interface Z (151)) to various user devices over a network or in a cloud computing environment. In particular, the user interface may provide parties with the capability to review the classification assessment regarding network elements or an organization as a whole. Likewise, a user interface may receive inputs from a user, such as cybersecurity analysts, regarding cybersecurity risks and security protocols. In some embodiments, for example, a cybersecurity assessment manager may include software to provide a graphical user interface for presenting data and/or receiving commands to initiate remediation actions with a network.

Keeping with FIG. 1, the cybersecurity assessment manager Z (150) may include functionality for generating one or more assessment reports (e.g., assessment report M (161), assessment reports (154)) based on cybersecurity data. In particular, the assessment report may include a report on assessment of the application based on the baseline selection criteria (302) and the requirements criteria, and alert the administrator. In some embodiments, an assessment report includes changes in the network with respect to particular measurements from a previous report.

Furthermore, an assessment report may indicate changes with respect to an overall cybersecurity assessment for a network or organization. Reports may also include updates regarding performance of current remediation procedures. Likewise, a cybersecurity assessment manager may store previous assessment reports (e.g., assessment reports (154) in a database, such as to compare and identify overall performance improvements at periodic intervals. Such assessment reports may be provided to user devices through a dashboard integration to a cybersecurity assessment manager's user interface. In some embodiments, a network element may host a software probe to inspect a configuration of this network element.

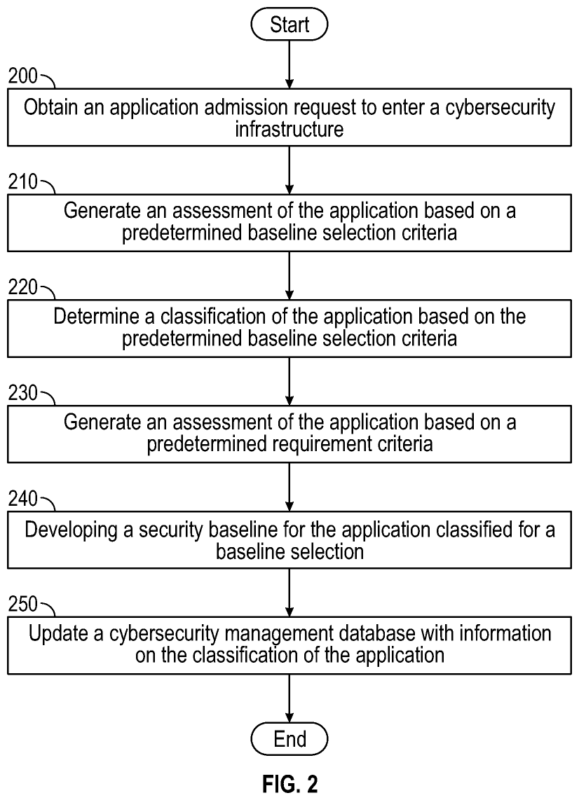

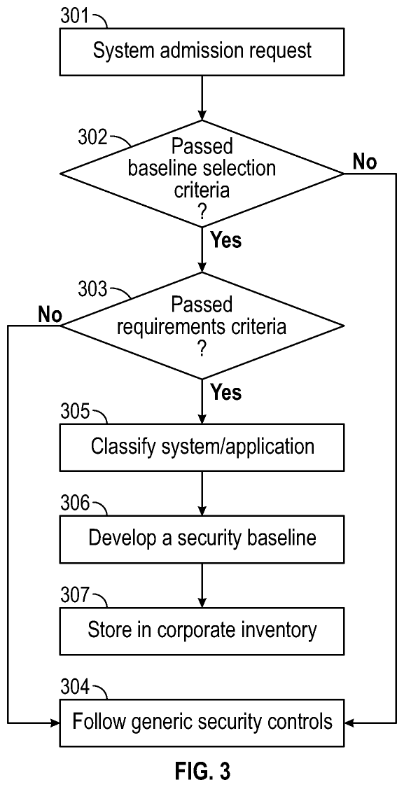

Turning to FIGS. 2 and 3, FIGS. 2 and 3 show flowcharts in accordance with one or more embodiments. Specifically, FIG. 2 describes a general method for enterprise cybersecurity baseline classification. Further, FIG. 3 describes a pathway of an application form requesting the access to the system to being admitted with corresponding security protocol. One or more blocks in FIGS. 2 and 3 may be performed by one or more components (e.g., cybersecurity assessment manager (150)) as described in FIG. 1. While the various blocks in FIGS. 2 and 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 200, one or more cybersecurity application admission requests are obtained in accordance with one or more embodiments. The cybersecurity application admission requests, cybersecurity data, and information about the application are stored in data repository (193) and includes activity of the network device, network interface card type, reservation status, switch port, asset details, or last scan time, physical location or the system name of the network element currently using the network. In one or more embodiments, the application information may include a type of system and application, a presence of a custom code, a presence of editable configuration, a presence of a security baseline, etc. The application information changes may be periodically collected by hardware and software probes or supplied by the user.

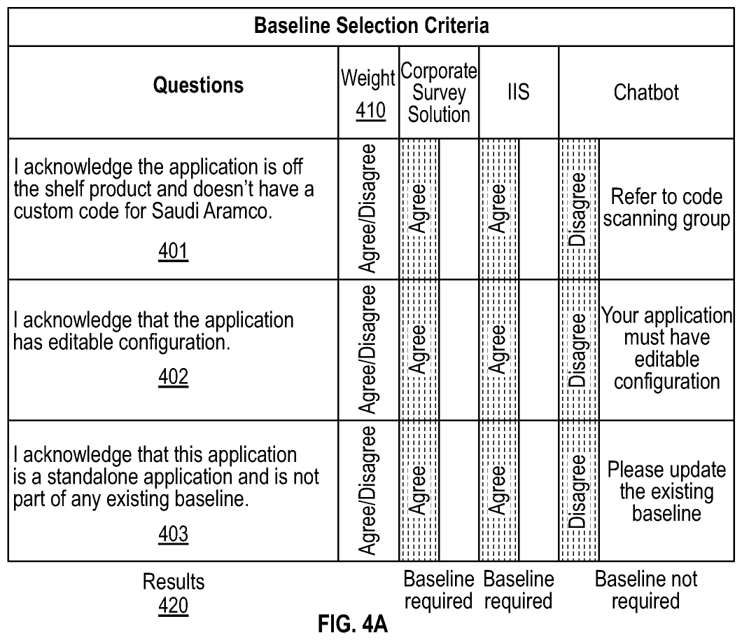

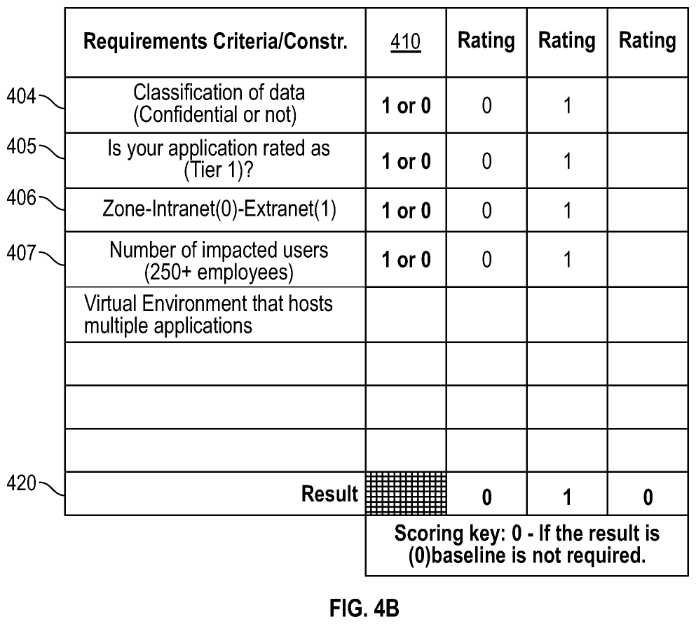

In Block 210, the algorithm engine (152) analyzes the application and based on baseline selection criteria, the algorithm engine (152) determines further action for the application. As shown in FIG. 3, after receiving the system admission request (301), the algorithm engine (152) initially assesses the application based on the baseline selection criteria (302). Further, as shown in FIG. 4A, the baseline selection criteria (302) may include, at least, requirements such as the application being an off the shelf product and not having a custom code (401), the application having an editable configuration (402), and the application being standalone application and not being a part of the existing baseline (403).

Further, the algorithm engine (152), grades each application based on the baseline selection criteria and assigns a score to the application or the system. This process may be performed periodically, or it can be performed after every reported addition or removal of the network element in a network. In one or more embodiments, a weight (410) of the answers may be binary, where one point is given for acceptable results and zero points are given for unacceptable responses. Alternatively, the weight (410) of the answers may be a natural number, a decimal number, a percentage, or any other metric, where the sum of the metrics is compared to predetermined thresholds. Only the applications with results (420) that satisfy the required baseline selection criteria (302) proceed to the system classification (303). The applications with results (420) that do not satisfy the required baseline selection criteria (302) proceed to follow the generic security controls (304) such as scanning the application's code, updating the existing baseline, and adding the editable configuration.

In Block 230, the algorithm engine (152) analyzes the classified applications and generates an assessment for the classified application. As shown in FIG. 3, after assessing the applications based on baseline selection criteria (302), the algorithm engine (152) assesses the applications based on the requirement criteria (303). Further, as shown on FIG. 4B, the requirement criteria (303) may include, at least, requirements such as confidentiality of the application (404), application's cybersecurity tier (405), application's admittance to intranet or extranet zone (406), a number of employees using the application (407), or any requirement that is determined as viable to the cybersecurity analyst.

Further, the algorithm engine (152), grades each application based on the requirement criteria (303) and assigns a score to the application or the system. This process may be performed periodically, or it can be performed after every reported addition or removal of the network element in a network. In one or more embodiments, a weight of the answers may be binary, where one point is given for acceptable results and zero points are given for unacceptable responses. Alternatively, the weight (410) of the answers may be a natural number, a decimal number, a percentage, or any other metric, where the sum of the metrics is compared to predetermined thresholds. Only the applications with results (420) that satisfy the required requirement criteria (303) proceed to the classification (305). The applications with results (420) that do not satisfy the required requirement criteria (303) proceed to follow the generic security controls.

In Block 230, the algorithm engine (152) classifies the applications based on the baseline selection criteria (302) and the requirement criteria (303). As shown in FIG. 3, after assessing the baseline selection criteria (302) and the requirement criteria (303), the algorithm engine (152) classifies the applications, that successfully satisfied both the baseline selection criteria (302) and the requirement criteria (303), as critical to continue the cybersecurity assessment. The applications that do not satisfy either the baseline selection criteria (302) or the requirement criteria (303), are classified as non-critical and they are sent to a generic security control (304)

This classification may be applied generally to any time-consuming process that necessitates defining the important factors between an owner and a user. Further, the classification helps in deciding what security operations should be prioritized. Furthermore, common security controls should be used if any system or application doesn't meet the requirements to make sure that the minimum security controls are satisfied.

In Block 240, the algorithm engine (152) develops a cybersecurity baseline for the applications. As shown in FIG. 3, if the applications pass the requirement criteria (303), the applications are classified as critical and a cybersecurity baseline (306) is developed. The cybersecurity baseline (306) includes one or more minimum security controls required for safeguarding the network system, based on the system's needs for security, integrity, and confidentiality. The baseline is then assessed on regular basis by security operations team to ensure any non-compliant items from the baseline is timely remediated.

In Block 250, after the assessment of whether the application is required a cybersecurity baseline or the application needs to follow the generic security controls, a record of the application assessment is then registered in a data repository (193) to document the status of system/application. The assessed application is admitted to the network with one of the corresponding security protocols.

Embodiments may be implemented on any suitable computing device, such as the computer system shown in FIG. 5. Specifically, FIG. 5 is a block diagram of a computer system (500) used to provide computational functionalities associated with described algorithms, methods, functions, processes, flows, and procedures as described in the instant disclosure, according to an implementation. The illustrated computer (500) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (500) may include a computer that includes an input device, such as a keypad, keyboard, touch screen, or other device that can accept user information, and an output device that conveys information associated with the operation of the computer (500), including digital data, visual, or audio information (or a combination of information), or a GUI.

The computer (500) can serve in a role as a client, network component, a server, a database or other persistency, or any other component (or a combination of roles) of a computer system for performing the subject matter described in the instant disclosure. The illustrated computer (500) is communicably coupled with a network (510). In some implementations, one or more components of the computer (500) may be configured to operate within environments, including cloud-computing-based, local, global, or other environment (or a combination of environments).

At a high level, the computer (500) is an electronic computing device operable to receive, transmit, process, store, or manage data and information associated with the described subject matter. According to some implementations, the computer (500) may also include or be communicably coupled with an application server, e-mail server, web server, caching server, streaming data server, business intelligence (BI) server, or other server (or a combination of servers).

The computer (500) can receive requests over network (510) from a client application (for example, executing on another computer (500) and responding to the received requests by processing the said requests in an appropriate software application. In addition, requests may also be sent to the computer (500) from internal users (for example, from a command console or by other appropriate access method), external or third-parties, other automated applications, as well as any other appropriate entities, individuals, systems, or computers.

Each of the components of the computer (500) can communicate using a system bus (570). In some implementations, any or all of the components of the computer (500), both hardware or software (or a combination of hardware and software), may interface with each other or the interface (520) (or a combination of both) over the system bus (570) using an application programming interface (API) (550) or a service layer (560) (or a combination of the API (550) and service layer (560). The API (550) may include specifications for routines, data structures, and object classes. The API (550) may be either computer-language independent or dependent and refer to a complete interface, a single function, or even a set of APIs. The service layer (560) provides software services to the computer (500) or other components (whether or not illustrated) that are communicably coupled to the computer (500). The functionality of the computer (500) may be accessible for all service consumers using this service layer. Software services, such as those provided by the service layer (560), provide reusable, defined business functionalities through a defined interface. For example, the interface may be software written in JAVA, C++, or other suitable language providing data in extensible markup language (XML) format or other suitable format. While illustrated as an integrated component of the computer (500), alternative implementations may illustrate the API (550) or the service layer (560) as stand-alone components in relation to other components of the computer (500) or other components (whether or not illustrated) that are communicably coupled to the computer (500). Moreover, any or all parts of the API (550) or the service layer (560) may be implemented as child or sub-modules of another software module, enterprise application, or hardware module without departing from the scope of this disclosure.

The computer (500) includes an interface (520). Although illustrated as a single interface (520) in FIG. 5, two or more interfaces (520) may be used according to particular needs, desires, or particular implementations of the computer (500). The interface (520) is used by the computer (500) for communicating with other systems in a distributed environment that are connected to the network (510). Generally, the interface (520 includes logic encoded in software or hardware (or a combination of software and hardware) and operable to communicate with the network (510). More specifically, the interface (520) may include software supporting one or more communication protocols associated with communications such that the network (510) or interface's hardware is operable to communicate physical signals within and outside of the illustrated computer (500).

The computer (500) includes at least one computer processor (530). Although illustrated as a single computer processor (530) in FIG. 5, two or more processors may be used according to particular needs, desires, or particular implementations of the computer (500). Generally, the computer processor (530) executes instructions and manipulates data to perform the operations of the computer (500) and any algorithms, methods, functions, processes, flows, and procedures as described in the instant disclosure.

The computer (500) also includes a memory (580) that holds data for the computer (500) or other components (or a combination of both) that can be connected to the network (510). For example, memory (580) can be a database storing data consistent with this disclosure. Although illustrated as a single memory (580) in FIG. 5, two or more memories may be used according to particular needs, desires, or particular implementations of the computer (500) and the described functionality. While memory (580) is illustrated as an integral component of the computer (500), in alternative implementations, memory (580) can be external to the computer (500).

The application (540) is an algorithmic software engine providing functionality according to particular needs, desires, or particular implementations of the computer (500), particularly with respect to functionality described in this disclosure. For example, application (540) can serve as one or more components, modules, applications, etc. Further, although illustrated as a single application (540), the application (540) may be implemented as multiple applications (540) on the computer (500). In addition, although illustrated as integral to the computer (500), in alternative implementations, the application (540) can be external to the computer (500).

There may be any number of computers (500) associated with, or external to, a computer system containing computer (500), each computer (500) communicating over network (510). Further, the term “client,” “user,” and other appropriate terminology may be used interchangeably as appropriate without departing from the scope of this disclosure. Moreover, this disclosure contemplates that many users may use one computer (500), or that one user may use multiple computers (500).

In some embodiments, the computer (500) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining an application admission request to enter a cybersecurity infrastructure;
generating, by a computer processor, an assessment of the application based on a predetermined baseline selection criteria;
generating, by the computer processor, an assessment of the application based on a predetermined requirement criteria;
determining, by the computer processor, a classification of the application based on the assessments, wherein the application is classified as critical or non-critical;
developing, by the computer processor, a security baseline for the application classified as critical; and
updating, by the computer processor, a cybersecurity management database with information on the classification of the application.

2. The method of claim 1, further comprising:
determining, by the computer processor, a first score of the application based on the assessment of the application using the predetermined baseline selection criteria; and
determining, by the computer processor, a second score of the application based on the assessment of the application using the predetermined requirement criteria.

3. The method of claim 2, wherein the classification is determined based on comparing the first score and the second score to a predetermined threshold.

4. The method of claim 1, further comprising:
generating, by the computer processor, a generic security control for the applications classified as non-critical; and
updating, by the computer processor, the cybersecurity management database with an information on the classification of the application.

5. The method of claim 1, wherein the cybersecurity management database stores classification information of a plurality of applications.

6. The method of claim 1, wherein the application admission request to enter the cybersecurity infrastructure is generated by a user or by a cybersecurity network.

7. The method of claim 4, wherein the generic security controls are NIST, DOD or enterprise's cybersecurity controls.

8. The method of claim 1, wherein the assessment of the application based on the predetermined baseline selection criteria includes application being an off-the-shelf product and not having a custom code, the application having an editable configuration, and the application being a standalone application and not being a part of an existing baseline.

9. The method of claim 1, wherein the assessment of the application based on the predetermined requirement criteria includes application's cybersecurity tier, application's admittance to an intranet or extranet zone, and a number of employees using the application.

10. A system, comprising:
a network comprising a plurality of network elements;
a hardware probe coupled to the plurality of network elements;
a network element coupled to the plurality of network elements, the network element comprising a software probe; and
a computer processor, wherein the computer processor is coupled to the hardware probe, the software probe, and the plurality of network elements, and wherein the computer processor comprises functionality for:
obtaining an application admission request to enter a cybersecurity infrastructure;
generating an assessment of the application based on a predetermined baseline selection criteria;
determining a classification of the application based on the predetermined baseline selection criteria;
generating an assessment of the application based on a predetermined requirement criteria;
developing a security baseline for the application classified for a baseline selection; and
updating a cybersecurity management database with information on the classification of the application.

11. The system of claim 10, wherein the computer processor further comprises functionality for:
determining a first score of the application based on the assessment of the application based on the predetermined baseline selection criteria; and
determining a second score of the application based on the assessment of the application based on the predetermined requirement criteria.

12. The system of claim 11, wherein the classification is determined based on comparing the first score and the second score to a predetermined threshold.

13. The system of claim 10, wherein the computer processor further comprises functionality for:
generating a generic security control for the applications classified as non-critical; and
updating the cybersecurity management database with an information on the classification of the application.

14. The system of claim 10, wherein the cybersecurity management database stores a classification information of a plurality of applications.

15. The system of claim 10, wherein the application admission request to enter the cybersecurity infrastructure is generated by a user or by the cybersecurity network.

16. A non-transitory computer readable medium storing instructions executable by a computer processor, the instructions comprising functionality for:
obtaining an application admission request to enter a cybersecurity infrastructure;
generating an assessment of the application based on a predetermined baseline selection criteria;
determining a classification of the application based on the predetermined baseline selection criteria;
generating an assessment of the application based on a predetermined requirement criteria;
developing a security baseline for the application classified for a baseline selection; and
updating a cybersecurity management database with information on the classification of the application.

17. The non-transitory computer readable medium of claim 16, wherein the instructions further comprise functionality for:
determining a first score of the application based on the assessment of the application based on the predetermined baseline selection criteria; and
determining a second score of the application based on the assessment of the application based on the predetermined requirement criteria.

18. The non-transitory computer readable medium of claim 17, wherein the classification is determined based on comparing the first score and the second score to a predetermined threshold.

19. The non-transitory computer readable medium of claim 16, wherein the instructions further comprise functionality for:
generating a generic security control for the applications classified as non-critical; and
updating the cybersecurity management database with an information on the classification of the application.

20. The non-transitory computer readable medium of claim 16, wherein the cybersecurity management database stores a classification information of a plurality of applications.
